(19) United States
(12) Patent Application Publication
(10) Pub. No.: US 2009/0215378 A1
(43) Pub. Date: Aug. 27, 2009

(54) Air-conditioning duct system

(75) Inventors: Nobuhiro Terai, Aichi-ken (JP); Takahiko Sato, Aichi-ken (JP); Shintaro Okawa, Aichi-ken (JP); Katsuhiro Katagiri, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/379,502

(22) Filed: Feb. 24, 2009

(30) Foreign Application Priority Data
Feb. 27, 2008 (JP) 2008-045488

(51) Int. Cl. B60H 1/34

(52) U.S. Cl. 454/152

(57) ABSTRACT

An outer tube part 8 and an inner tube part 6 which is disposed in an interior of the outer tube part 8 are provided in an air-conditioning duct system which is connected to an air flow path downstream side of a vehicle air-conditioning system, and a side branch type silencer chamber 9 is defined by an inner circumferential surface of the outer tube part 8 and an outer circumferential surface of the inner tube part 6. In addition, an axis of at least a portion of the outer tube part 8 which confronts the inner tube part 6 and an axis of the inner tube part 6 are both made to be a straight line, and a register functioning part is provided in an interior of a portion of the outer tube part 8 which lies further downstream in an air flow path than the inner tube part 6.

### FIELD OF THE INVENTION

The present invention relates to an air-conditioning duct system which is connected to a downstream side of an air flow path of a vehicle air-conditioning system.

### DESCRIPTION OF THE RELATED ART

An air-conditioning duct which is connected to a vehicle air-conditioning system (a so-called air-conditioner) is formed into a tubular shape. Air blown out of the vehicle air-conditioning system (hereinafter, referred to as conditioned air) flows in an interior of the air-conditioning duct. Consequently, noise attributed to the vehicle air-conditioning system is transmitted to the air-conditioning duct. To reduce the noise so transmitted, there is proposed a technique for integrating a resonator and a side branch into an air-conditioning duct. In a general air-conditioning duct into which a resonator and a side branch are integrated, however, the resonator and the side branch (hereinafter, referred to as a silencer chamber) project outwards largely. Because of this, there has been caused a problem that the air-conditioning duct is enlarged remarkably.

There has also been proposed a technique in which a silencer chamber is provided in an interior of an inlet duct to thereby reduce noise without enlarging the inlet duct (for example, refer to Patent Document 1). As is introduced in Patent Document 1, by integrating the silencer chamber into the air-conditioning duct, noise can be reduced, and moreover, there is a possibility that a small air-conditioning duct can be fabricated.

The silencer chamber introduced in Patent Document 1 is a side branch type silencer chamber. This silencer chamber is defined by an inner circumferential surface of a tubular outer tube part and an outer circumferential surface of a tubular inner tube part. Specifically, the inner tube part is disposed in an interior of the outer tube part, and an axial end (referred to as a first inner end) of the inner tube part is integrated with the inner circumferential surface of the outer tube part, while the other axial end (referred to as a second inner end) of the inner tube part is disposed further downstream in an air flow path than the first inner end. In addition, an outer circumferential surface of the second inner end is spaced apart from the inner circumferential surface of the outer tube part.

Incidentally, in the case of a silencer chamber being provided in an interior of an air-conditioning duct, the silencer chamber interferes with conditioned air, leading a possibility that a turbulent flow is generated in the interior of the air-conditioning duct. When a turbulent flow is so generated, there is caused a fear that a pressure loss in the air-conditioning duct is increased.

To suppress the generation of turbulent flow, it is considered good that an axis of a portion of the air-conditioning duct which includes the silencer chamber is made to form a straight line so that conditioned air flows in a straight line. This is because in the event that conditioned air flows in a straight line, it becomes difficult for a turbulent flow to be generated. However, it is sometimes found difficult to provided a portion whose axis becomes a straight line (hereinafter, referred to as a straight-line section) in an air-conditioning duct which is normally short in its axial direction. In general, the air-conditioning duct is connected to a downstream side of an air flow path in a vehicle air-conditioning system, and a register is connected to a downstream side of the air-conditioning duct in the air flow path. Consequently, the length of the air-conditioning duct is determined by a distance between the vehicle air-conditioning system and the register. For example, in general, a distance between a vehicle air-conditioning system and a center register (which is a register disposed at the front of a vehicle and between a driver's seat and a front passenger's seat is very short, and the length of the air-conditioning duct which connects the two members to each other becomes very short. Hence, it becomes difficult to provide a straight-line section of a sufficient length in an air-conditioning duct like the one described above.

In addition, the frequency of noise (hereinafter, referred to as a suppression target noise) that can be made silent by a silencer chamber is determined by the length of the silencer chamber. Because of this, there is also caused a problem that it becomes difficult to make a suppression target noise silent unless the straight-line section has a sufficient length.

Patent Document 1: JP-A-2001-248508

The invention has been made in view of the situations, and an object thereof is to provide an air-conditioning duct system which is not bulky and which can silence suppression target noise highly reliably while suppressing an increase in pressure loss.

### SUMMARY OF THE INVENTION

With a view to achieving the object, according to an aspect of the invention, there is provided an air-conditioning duct system which is connected to a downstream side of an air flow path of a vehicle air-conditioning system, including a tubular outer tube part 8, a tubular inner tube part 6 which is disposed in an interior of the outer tube part 8 and in which a first inner end 61, which is an axial end, is integrated with an inner circumferential surface of the outer tube part 8, a second inner end 62, which is the other axial end, is disposed further downstream in the air flow path than the first inner end 61, and an outer circumferential surface of the second inner end 62 and the inner circumferential surface of the outer tube part 8 are spaced apart, a side branch type silencer chamber 9 which is defined between the inner circumferential surface of the outer tube part 8 and the outer circumferential surface of the inner tube part 6, and a register functioning part 4 having a fin group in which a plurality of fins are aligned and disposed in the interior of the outer tube part 8 in a position lying further downstream in the air flow path than the inner tube part 6, wherein an axis of at least a portion of the outer tube part 8 which confronts the inner tube part 6 and an axis of the inner tube part 6 both constitute a straight line.

The air-conditioning system according to the aspect of the invention preferably includes the following configurations (1) to (2) below.

(1) A configuration in which an outer tube downstream portion 3 which constitutes a portion of the outer tube part 8 which lies downstream in the air flow path and an outer tube upstream portion 5 which constitutes a portion of the outer tube part 8 which lies upstream in the air flow path are separate elements, in which an air flow path downstream side end portion of the outer tube upstream portion 5 is formed integrally with an air flow path upstream side end portion of the inner tube part 6, and in which the outer tube downstream portion 3 and the outer tube upstream portion 5 are assembled to each other so as to be integrated into a unit.
(2) A configuration in which the outer tube downstream portion 3 is a retainer of a register.

The air-conditioning duct system of the invention is such that an air-conditioning duct and a register are integrated into one unit. Since the air-conditioning duct system of the invention has the side branch type silencer chamber, noise can be silenced. In addition, since the side branch type silencer chamber is formed in the interior of the air-conditioning duct system, the air-conditioning duct system of the invention is not bulky. Further, the air-conditioning duct system of the invention includes the register integrally. Because of this, the air-conditioning duct system of the invention is not bulky compared with a case where an air-conditioning duct and a register are provided separately.

In addition, in the air-conditioning duct system of the invention, the axis of the portion of the outer tube part which confronts the inner tube part (hereinafter, referred to as a confronting portion) and the axis of the inner tube part both constitute the straight line. Consequently, the air-conditioning duct system of the invention holds the straight-line section, and the side branch type silencer chamber is provided in the straight-line section. Because of this, in the air-conditioning duct system of the invention, the generation of turbulent flow can be suppressed, and an increase in pressure loss can be suppressed.

Incidentally, an axis of an air flow path upstream side end portion of a register in general is formed into a straight line. This is done to regulate conditioned air introduced into the register. In the air-conditioning duct system of the invention, the air flow path upstream side end portion of the register is made use of as the straight-line section, and the side branch type silencer chamber is provided in the straight-line section. Because of this, according to the air-conditioning duct system of the invention, even through the axial length of the portion which functions as an air-conditioning duct (namely, the portion of the air-conditioning duct system which lies further upstream in the air flow path than the side branch type silencer chamber) is short, a silencer chamber having a sufficient size can be provided. Because of this, the air-conditioning duct system of the invention can silence the suppression target noise highly reliably and is not bulky. This is due to the following reasons.

The air-conditioning duct system including the configuration (1) above can easily be fabricated, can silence the suppression target noise highly reliably and is not bulky. This is due to the following reasons.

The air-conditioning duct system of the invention makes up a double tube configuration which has the inner tube part and the outer tube part. Because of this, it is difficult to form the inner tube part and the outer tube part integrally. According to the air-conditioning duct system of the invention which includes the configuration (1) above, the portion of the outer tube which lies on the upstream side of the air flow path (the outer tube upstream portion) and the portion of the outer tube which lies on the downstream side of the air flow path (the outer tube downstream portion) are formed separately, and by assembling both the portions together to integrate them into one unit, whereby the air-conditioning duct system can easily be fabricated. In addition, by forming integrally the inner tube part and the outer tube upstream portion, the air-conditioning duct system can be fabricated more easily, and the side branch type silencer chamber can be formed highly accurately in terms of dimensions. Incidentally, in general, an air-conditioning duct and a register are formed separately from each other, and thereafter, the duct and the register are assembled together so as to be integrated into one unit. According to the air-conditioning duct system of the invention which includes the configuration (1) above, by making use of the assembling portion where the air-conditioning duct and the register are assembled tighter, the outer tube upstream portion and the outer tube downstream portion are integrated together. Because of this, the air-conditioning duct system of the invention which includes the configuration (1) above can reduce the number of assembling portions and hence does not become bulky.

### BRIEF DESCRIPTION OF THE DRAWINGS

FIG. 1 is an explanatory diagram showing exemplarily a state in which air-conditioning duct system of Embodiment 1 is taken along an axial direction thereof.

FIG. 2 is a sectional view showing exemplarily a state in which the air-conditioning duct system of Embodiment 1 is taken along a radial direction thereof.

FIG. 3 is an explanatory diagram showing exemplarily a state in which an air-conditioning duct system of Embodiment 2 is taken along an axial direction thereof.

### DESCRIPTION OF THE PREFERRED EMBODIMENTS

An outer tube part of an air-conditioning duct system of the invention may only have to be tubular and hence can be formed into various tubular shapes including a circular tube and an angular tube. Similarly, an inner tube part may only have to be tubular and hence can be formed into various tubular shapes including a circular tube and an angular tube. The thickness of the outer tube part and the inner tube part may be constant or may not be constant. In addition, an axis of the outer tube part and an axis of the inner tube part may coincide with each other or may not coincide with each other. Namely, an interval between an inner circumferential surface of the outer tube part and the inner tube part may be constant in a circumferential direction or may not be so constant. In order to suppress the generation of turbulent flow in a portion of the outer tube part which lies further downstream in an air flow path than the inner tube part (that is, an outer tube downstream portion), the axis of the outer tube part and the axis of the inner tube part preferably coincide with each other.

Two or more portions which are different in axial length may be provided in the inner tube part. In this case, two or more types of suppression target noise can be silenced.

Furthermore, in the air-conditioning duct system of the invention, a portion where a radial cross section of the inner circumferential surface is constant (hereinafter, referred to as an air flow regulating portion) may be provided in a portion of the outer tube upstream portion which continuously connects to an air flow path upstream side of the inner tube part. Hereinafter, radial cross sections of the inner circumferential surfaces of the respective portions of the air-conditioning duct system of the invention will be simply referred to as radial cross sections. Similarly, radial sectional areas of the inner circumferential surfaces of the respective portions of the air-conditioning duct system of the invention will be simply referred to as radial sectional areas. When an air flow regulating portion is provided in the air-conditioning duct system of the invention, the flowing direction of conditioned air which flows into the side branch type silencer chamber can be regulated by the air flow regulating portion. Because of this, the generation of turbulent flow in the air-conditioning duct system can be suppressed with higher reliability. An axis of the air flow regulating portion may be formed into a curve but it will be better that the axis of the air flow regulating portion is formed into a straight line. In the event that the axis of the air flow regulating portion is formed into a straight line, the generation of turbulent flow in the air-conditioning duct system can be suppressed with much higher reliability.

A plurality of groups of fins may be provided in the air-conditioning duct system of the invention. In the event that a plurality of fin groups are provided, the blowing out direction of conditioned air can be adjusted more variously. Furthermore, a damper for opening and closing the air flow path may be provided in the air-conditioning duct system of the invention. The damper may make up part of a register functioning part or may not make up the same. Namely, the damper may be disposed further upstream in the air flow path than the inner tube part or may be disposed in an interior of the inner tube part.

In the air-conditioning duct system of the invention, a portion of the outer tube part which lies upstream in the air flow path (an outer tube upstream portion) and a portion of the outer tube part which lies downstream in the air flow path (an outer tube downstream portion) may be formed integrally or may be formed separately. In addition, the inner tube part and the outer tube part may be formed integrally, or the inner tube part and the outer tube part may be formed separately and be assembled together so as to be integrated into one unit. When the inner tube part and the outer tube part are assembled together so as to be integrated into one unit, the inner tube part may be disposed between the outer tube upstream portion and the outer tube downstream portion in such a manner as to be held therebetween when the outer tube upstream portion and the outer tube downstream portion are assembled together so as to be integrated into one unit. Furthermore, the outer tube upstream portion, the outer tube downstream portion and the inner tube part may be formed separately, or the outer tube upstream portion, the outer tube downstream portion and the inner tube part may be integrated into one unit and thereafter may be cut to be divided into separate elements. When the outer tube upstream portion, the outer tube downstream portion and the inner tube part are formed integrally and thereafter are cut to be divided into separate elements, there is provided an advantage that the number of molds for used in forming those constituent members can be decreased.

When the outer tube upstream portion and the outer tube downstream portion are assembled together so as to be integrated into one unit, the register functioning part may be assembled to the outer tube downstream portion after the outer tube upstream portion and the outer tube downstream portion have been assembled together, or the register functioning part may be assembled to the outer tube downstream portion before the outer tube upstream portion and the outer tube downstream portion are assembled together. In addition, the register function part may be formed integrally with the outer tube downstream portion by the use of such a method as a two-color forming method.

The fins may be made to swing or may not be made to swing. In the vent that the fins are made to swing, the blowing out direction of conditioned air can be changed by causing the fins to swing.

Hereinafter, air-conditioning duct systems according to embodiments of the invention will be described based on the accompanying drawings.

### Embodiment 1

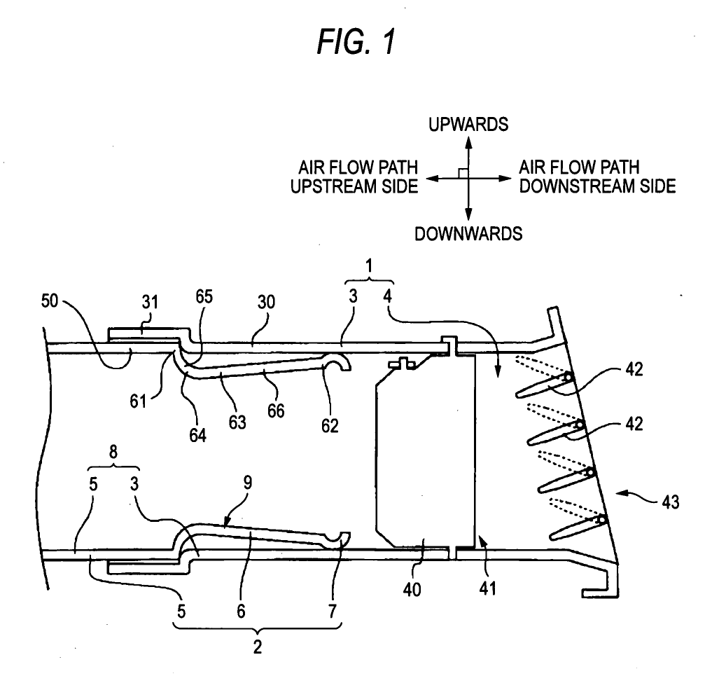

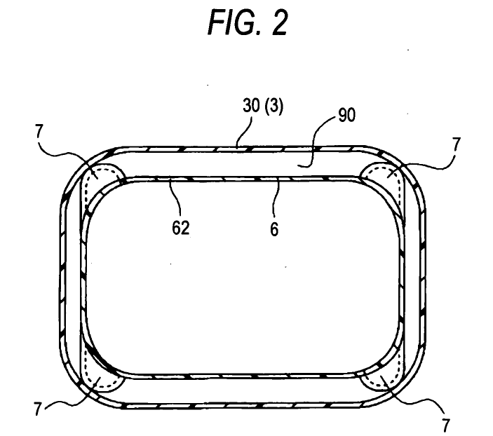

An air-conditioning duct system of Embodiment 1 includes the configuration (1) above. An explanatory diagram is shown in FIG. 1 which represents exemplarily a state in which the air-conditioning duct system of Embodiment 1 is taken along an axial direction thereof. A sectional view is shown in FIG. 2 which represents exemplarily a state in which the air-conditioning duct system of Embodiment 1 is taken along a radial direction thereof. Hereinafter, in Embodiment 1, up or upwards, down or downwards, air flow path upstream side and air flow path downstream side denote respectively up or upwards, down or downwards, air flow path upstream side and air flow downstream side shown in FIG. 1. In addition, left and right denote directions which intersect the directions denoted by up or upwards, down or downwards, airflow path upstream side and air flow path downstream side in FIG. 1.

An air-conditioning duct system of Embodiment 1 is connected to a downstream side in an air flow path of a vehicle air-conditioning system (whose illustration is omitted). The air-conditioning duct system of Embodiment 1 includes a substantially angularly tubular first divided element 1 and a substantially angularly tubular second divided element 2. The first divided element 1 constitutes a part of the air-conditioning duct system which lies on a downstream side of the air flow path. The second divided element 2 constitutes a part of the air-conditioning duct system which lies on an upstream side of the air flow path. The first divided element 1 includes an outer tube downstream portion 3 and a resister functioning part 4. The outer tube downstream portion 3 includes a confronting portion 30. The register functioning part 4 is integrated into an interior of the outer tube downstream portion 3 which lies on the downstream side of the air flow path. The confronting portion 30 is made up of an air flow path upstream side end portion of the outer tube downstream portion 3. The second divided element 2 includes an outer tube upstream portion 5, an inner tube part 6, and a spacer 7 part. The outer tube upstream portion 5 includes an air flow regulating portion 50. The inner tube part 6 is integrated into an air flow path downstream side end portion (that is, a portion which continuously connects to an air flow path upstream side of the inner tube part 6) of the outer tube upstream portion 5. In addition, an outer tube part 8 of the air-conditioning duct system of Embodiment 1 is made up of the outer tube upstream portion 5 and the outer tube downstream portion 3. Further, an air flow path downstream side end portion of the outer tube downstream portion 3 is made to open to an inside of a passenger compartment, so that conditioned air is blown out therethrough into the passenger compartment. The register functioning part 4 adjusts the blowing out direction of the conditioned air that is blown out into the passenger compartment. Consequently, the outer tube downstream portion 3 and the register functioning part 4 correspond to a register, and the outer tube downstream portion 3 corresponds to a retainer of the register.

An air flow path upstream side end portion (which is a portion lying further upstream than the confronting portion 30 in the air flow path) of the outer tube downstream portion 3 is slightly expanded diametrically. This diametrically expanded portion is referred to as a connecting end portion 31. A portion of the outer tube upstream portion which lies upstream in the air flow path and the inner tube part 6 are inserted into the outer tube downstream portion 3, and the connecting end portion 31 fits on an end portion of the air flow regulating portion 50 which lies to face the inner tube part 6. In addition, an adhesive layer, whose illustration is omitted, is laminated on an inner circumferential surface of the connecting end portion 31. The first divided element 1 and the second divided element 2 are bonded together by the adhesive layer, to thereby be integrated with each other in a closely airtight fashion. When the first divided element 1 and the second divided element 2 are integrated together, the confronting portion 30 of the outer tube downstream portion 30 covers an outer circumferential side of the inner tube part 6 to thereby confront the inner tube part 6. In addition, as this occurs, the register functioning part 4 is disposed further downstream than the inner tube part 6 in the air flow path.

The register functioning part 40 includes a vertical fin group 41 in which a plurality of vertical fins 40 are aligned in a horizontal direction and a horizontal fin group 43 in which a plurality of horizontal fins 42 are aligned in a vertical direction. Each vertical fin 40 is formed into a strip which extends in the vertical direction and is pivotally supported on an upper wall and a lower wall of the outer tube downstream portion 3. Each horizontal fin 42 is formed into a strip which extends in the horizontal direction and is pivotally supported on a left wall and a right wall of the outer tube downstream portion 3. Consequently, the vertical fins 40 and the horizontal fins 42 can swing. The respective vertical fins 40 are connected to one another by a vertical link device, whose illustration is omitted, so as to swing altogether in a synchronous fashion. The respective horizontal fins 42 are also connected to one another by a horizontal link device, whose illustration is omitted, so as to swing altogether in a synchronous fashion.

A radial sectional area of the outer tube upstream portion 5 and a radial sectional area of the outer tube downstream portion 3 which excludes the connecting end portion 31 are substantially constant. Axes of the outer tube upstream portion 5, the outer tube downstream portion 3 and the inner tube part 6 are made to form a straight line. In addition, the outer tube upstream portion 5, the outer tube downstream portion 3 and the inner tube part 6 are disposed concentrically.

The inner tube part 6 includes a first inner end 61, a second inner end 62, and a constricted portion 63. The first inner end 61 constitutes an air flow path upstream side end portion of the inner tube part 6, continuously connects to an air flow path downstream side of the air flow regulating portion 50 and is integrated with an inner circumferential surface of the outer tube upstream portion 5. The second inner end 62 constitutes an air flow path downstream side end portion of the inner tube part 6. An outer circumferential surface of the second inner end 62 and an inner circumferential surface of the outer tube downstream portion 3 are spaced apart from each other and a gap is formed therebetween. This gap constitutes an open end face 90 of a side branch type silencer chamber 9, which will be described later.

The constricted portion 63 is a portion which lies between the first inner end 61 and the second inner end 62 and connects the first inner end 61 with the second inner end 62. A portion of the constricted portion 63 which lies upstream in the air flow path has a smallest radial sectional area in the inner tube part 6. This portion is referred to as a smallest diameter portion 64. The radial sectional area of the inner tube part 6 is decreased drastically as the inner tube part 6 extends from the first inner end 61 towards the smallest diameter portion 64. In addition, the radial sectional area of the inner tube part 6 is increased gradually as the inner tube part 6 extends from the smallest diameter portion 64 towards the second inner end 62. As has been described above, the outer circumferential surface of the second inner end 62 and the inner circumferential surface of the first divided element or outer tube part 1 are spaced apart from each other. Consequently, a radial sectional area of the constricted portion 63 is smaller than a radial sectional area of the first inner end 61.

An axial length of the air flow regulating portion 50 is 94 mm. A radial sectional area of the air flow regulating portion 50 is 4976 mm². A radial sectional area of the smallest diameter portion 64 is 2372 mm². A line which cuts axially a portion of the inner tube part 6 extending from the first inner end 61 to the smallest diameter portion 64 (hereinafter, referred to as a constriction drastically changing portion 65) is formed into an arc. A radius of the arc is 10 mm. An axial length of the constriction drastically changing portion 65 is also 10 mm. An axial length of a portion of the inner tube part 6 extending from the smallest diameter portion 64 to the second inner end 62 (hereinafter, referred to as returning portion 66) is 85 mm. A distance between the outer circumferential surface of the second inner end 62 and an inner circumferential surface of the confronting portion 30 (a radial length of the open end face) is 5 mm.

The spacer part 7 is gradually integrated into the air flow path downstream end portion of the inner tube part 6. Specifically, as is shown in FIG. 2, the spacer part 7 is formed into a projection and is integrated into four corners of the second inner end 62. A projecting end portion of the spacer part 7 is brought into abutment with the inner circumferential surface of the outer tube downstream portion 3. The spacer part 7 functions as a spacer for keeping a distance between the outer circumferential surface of the second inner end 62 and the inner circumferential surface of the confronting portion 30 (that is, a radial length of the open end face 90) to a predetermined distance.

In the air-conditioning duct system of Embodiment 1, a space is defined between the outer circumferential surface of the inner tube part 6 and the inner circumferential surface of the confronting portion 30. This space is made to communicate with an inner circumferential side of the inner tube part 6 via the gap (that is, the open end face 90) between the outer circumferential surface of the inner second end 62 and an inner circumferential surface of an outer tube part. Consequently, in the air-conditioning duct system of Embodiment 1, a side branch type silencer chamber 9 is formed by the inner tube part 6 and the confronting surface 31. Therefore, in the air-conditioning duct system of the invention, noise can be reduced by this side branch type silencer chamber 9. In addition, since the side branch type silencer chamber 9 is formed in the interior of the air-conditioning duct system, the air-conditioning duct system of Embodiment 1 does not become bulky even though the air-conditioning duct system includes the side branch type silencer chamber 9.

Incidentally, a resonance frequency f0 of a side branch type silencer can be calculated based on the following expression 1. In the event that f0 is made to coincide with or approximate to the frequency of suppression target noise, the suppression target noise can be silenced.

f0=c/4(l+Δ1) [Expression 1]

where, c denotes the sound velocity, l denotes a tube length of a side branch type silencer, and Δ1 denotes a corrected length of the side branch type silencer which is dependent upon open end area and opening peripheral boundary.

The open end face 90 of the air-conditioning duct system of Embodiment 1 corresponds to an open end face of the side branch type silencer. An axial length of the side branch type silencer chamber 9 (that is, the axial length of the inner tube part 6) corresponds to the tube length l of the side branch type silencer.

Letting an axial length of the constriction drastically changing portion 65 of the air-conditioning duct system of Embodiment 1 be W1 and an axial length of the portion of the inner tube part 6 extending from the smallest diameter portion 64 to the second inner end 62 (hereinafter, referred to as a returning portion 66) be W2, the tube length l of the air-conditioning system of Embodiment 1 is W1 or larger and a sum of W1 and W2 or smaller, which is 85 to 95 mm. Because of this, suppression target noise of the air-conditioning duct system of Embodiment 1 becomes noise whose frequency ranges from 900 to near 1000 Hz. In addition, the frequency of noise generated in the vehicle air-conditioning system is lying mainly in the vicinity of 1000 Hz. Because of this, according to the air-conditioning duct system of Embodiment 1, the suppression target noise or noise generated in the vehicle air-conditioning system can be reduced highly reliably.

In addition, an axis of the confronting portion 30 and an axis of the inner tube part of the air-conditioning duct system of Embodiment 1 both constitute a straight line. Because of this, the side branch type silencer chamber 9 of the air-conditioning duct system of Embodiment 1 is provided in a straight-line section. Because of this, according to the air-conditioning duct system of Embodiment 1, the generation of turbulent flow can be suppressed, and an increase in pressure loss can be suppressed.

Additionally, the air-conditioning duct system of Embodiment 1 includes the register functioning part 4, and the portion of the outer tube downstream portion 3 which lies further upstream in the air flow path than the register functioning part 4 is made use of the straight-line section. Because of this, in the air-conditioning duct system of Embodiment 1, even though the length of a portion which corresponds to the air-conditioning duct (that is, the portion lying further upstream in the air flow path than the register functioning part 4) is short, the axial length of the side branch type silencer chamber 9 can be made to have a sufficient length. Consequently, the air-conditioning duct system of Embodiment 1 can silence the suppression target noise highly reliably and does not become bulky.

In addition, in the air-conditioning duct system of Embodiment 1, the outer tube upstream portion 5 into which the inner tube part is integrated and the outer tube downstream portion 3 into which the register functioning part 4 is integrated are formed as separate elements, and the separate elements so formed are then assembled together for integration. Because of this, the air-conditioning duct system of Embodiment 1 can easily be fabricated and does not become bulky.

Additionally, the air-conditioning duct system of Embodiment 1 includes the air flow regulating portion 50. Since the radial section of the air flow regulating portion 50 remains constant, the flowing direction of conditioned air blown out of the vehicle air-conditioning system is regulated into a constant direction which is associated with the inner circumferential surface of the air flow regulating portion 50. Consequently, the flowing direction of conditioned air which flows into the constricted portion 63 is regulated in advance by the air flow regulating portion 50, thereby making it difficult for a turbulent flow to be generated in the constricted portion 63. Consequently, according to the air-conditioning duct system of Embodiment 1, an increase in pressure loss can be suppressed highly reliably.

In the air-conditioning duct system of Embodiment 1, the radial sectional area of the constricted portion is smaller than the radial sectional area of the first inner end 61. Because of this, noise transmitted to the air-conditioning duct system of the invention is dampened when it passes through the constricted portion 63. By this configuration, too, the air-conditioning duct system of Embodiment 1 can reduce the noise highly reliably.

In the air-conditioning duct system of Embodiment 1, the inner circumferential surface of the portion of the constricted portion 63 extending from the first inner end 61 to the smallest diameter portion 64 (that is, the constriction drastically changing portion 65) smoothly and continuously connects to the inner circumferential surface of the portion of the constricted portion 63 extending from the smallest diameter portion 64 to the second inner end 62 (that is, the returning portion 66). Because of this, after having passed through the air flow regulating portion 50, conditioned air then flows smoothly into the returning portion 66 by way of the constriction drastically changing portion 65. Because of this, according to the air-conditioning duct system of Embodiment 1, the generation of turbulent flow in the constricted portion 63 can be suppressed highly reliably.

Since the air-conditioning duct system of Embodiment 1 includes the spacer part 7, the outer circumferential surface of the second inner end 62 can be suppressed from approaching the inner circumferential surface of the confronting part 30, whereby the distance between the outer circumferential surface of the second inner end 62 and the inner circumferential surface of the confronting surface 30 (the radial length of the open end face 90) can be kept the predetermined distance. By this configuration, too, the air-conditioning duct system of Embodiment 1 can suppress the noise highly reliably.

### Embodiment 2

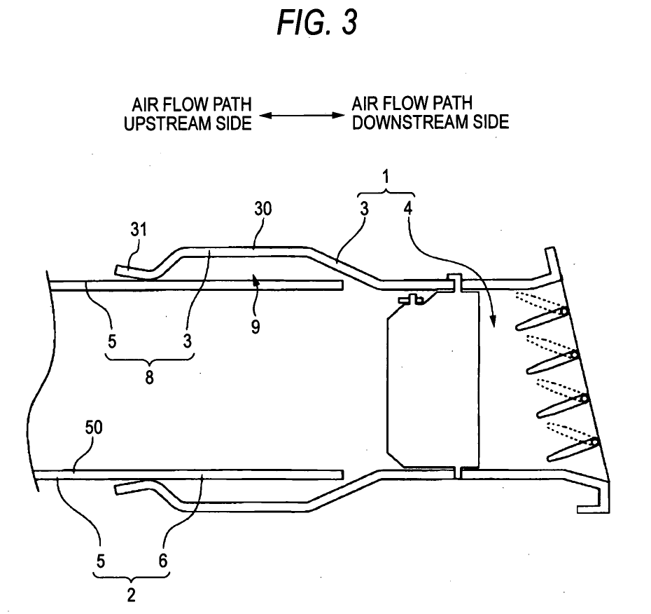

An air-conditioning duct system of Embodiment 2 includes the configuration (1) above. The air-conditioning duct system of Embodiment 2 is identical to the air-conditioning duct system of Embodiment 1 except features that no spacer part is provided and that configurations of an inner tube part and a confront portion differ from those of the air-conditioning duct system of Embodiment 1. An explanatory diagram is shown in FIG. 3 which shows exemplarily a state in which an air-conditioning duct system of Embodiment 2 is taken along an axial direction thereof. Hereinafter, in Embodiment 2, air flow path upstream side and air flow path downstream side denote air flow path upstream side and air flow path downstream side shown in FIG. 3.

An inner tube part 6 of the air-conditioning duct system of Embodiment 2 continuously connects to an air flow path downstream side of an outer tube upstream portion 5 (an air flow regulating portion 50). A radial sectional area of the inner tube part 6 and a radial sectional area of the air flow regulating portion 50 are both constant. In addition, the radial sectional area of the inner tube part 6 and the radial sectional area of the air flow regulating portion 50 are the same.

A confronting portion 30 is expanded diametrically compared with an air flow path downstream side end portion of the outer tube downstream portion 30. A portion of the outer tube downstream portion 3 which lies further upstream in the air flow path than the confronting portion 30 (a connecting end portion 31) is smaller in diameter than the confronting portion 30 and is diametrically expanded slightly larger than the outer tube upstream portion 5. an air flow path downstream side portion of the outer tube upstream portion 5 and the inner tube part 6 are inserted into the outer tube downstream portion 3, and the connecting end portion 31 fits on an end portion of the air flow regulating portion 50 which lies to face the inner tube part 6.

A register functioning part 4 is integrated into a portion of the outer tube downstream portion 3 which lies further downstream in the air flow path than the confronting portion 30. A first divided element 1 includes the outer tube downstream portion 3 and the register functioning part 4. A second divided element 2 includes the outer tube upstream portion 5 and the inner tube part 6. An outer tube part 8 is made up of the outer tube upstream portion 5 and the outer tube downstream portion 3. The first divided element 1 and the second divided element 2 are separate elements, which are assembled together so as to be integrated into one unit. When the first divided element 1 and the second divided element 2 are integrated into each other, the confronting portion 30 of the outer tube downstream portion 3 covers an outer circumferential side of the inner tube part 6 and then confronts the inner tube art 6. In addition, a side branch type silencer chamber 9 is defined by an inner circumferential surface of the confronting portion 30 and an outer circumferential surface of the inner tube part 6. As this occurs, the register functioning part 4 is disposed further downstream in the air flow path than the inner tube part 6.

The inner tube part 6 of the air-conditioning duct system of Embodiment 2 does not include a constricted portion. Because of this, the air-conditioning duct system of Embodiment 2 does not include a noise reducing function to reduce noise attributed to the constricted portion. However, as with the air-conditioning duct system of Embodiment 1, the air-conditioning duct system of Embodiment 2 can silence suppression target noise by the side branch type silencer chamber 9.

In addition, an axis of the confronting portion 30 and an axis of the inner tube part are both a straight line. Because of this, the side branch type silencer chamber 9 of the air-conditioning duct system of Embodiment 2 is provided in a straight-line section. Because of this, the air-conditioning duct system of Embodiment 2 can also suppress the generation of turbulent flow, and an increase in pressure loss can be suppressed.

Additionally, the air-conditioning duct system of Embodiment 2 includes the register functioning part 4 and makes use of the portion of the outer tube downstream portion 3 which lies further upstream in the air flow path than the register functioning part 4 as the straight-line section. Because of this, according to the air-conditioning duct system of Embodiment 2, even though the length of the portion of the air-conditioning duct system which lies further upstream in the air flow path than the register functioning part 4 is short, an axial length of the side branch type silencer chamber 9 can be made sufficient, whereby the air-conditioning duct system of Embodiment 2 can silence suppression target noise highly reliably and does not become bulky.

In addition, in the air-conditioning duct system of Embodiment 2, since the outer tube upstream portion 5 into which the inner tube part 6 is integrated and the outer tube downstream portion 3 into which the register functioning part 4 is integrated are formed separately, and both the outer tube downstream portion 5 and the outer tube downstream portion 3 are assembled together for integration, the air-conditioning duct system of Embodiment 2 can easily be fabricated and does not become bulky.

What is claimed is:

1. An air-conditioning duct system which is connected to a downstream side of an air flow path of a vehicle air-conditioning system, comprising:
a tubular outer tube part;
a tubular inner tube part which is disposed in an interior of the outer tube part and in which a first inner end, which is an axial end, is integrated with an inner circumferential surface of the outer tube part, a second inner end, which is the other axial end, is disposed further downstream in the air flow path than the first inner end, and an outer circumferential surface of the second inner end and the inner circumferential surface of the outer tube part are spaced apart;
a side branch type silencer chamber which is defined between the inner circumferential surface of the outer tube part and the outer circumferential surface of the inner tube part; and
a register functioning part having a fin group in which a plurality of fins are aligned and disposed in the interior of the outer tube part in a position lying further downstream in the air flow path than the inner tube part, wherein
an axis of at least a portion of the outer tube part which confronts the inner tube part and an axis of the inner tube part both constitute a straight line.

2. The air-conditioning duct system, wherein an outer tube downstream portion which constitutes a portion of the outer tube part which lies downstream in the air flow path and an outer tube upstream portion which constitutes a portion of the outer tube part which lies upstream in the air flow path are separate elements;
an air flow path downstream side end portion of the outer tube upstream portion is formed integrally with an air flow path upstream side end portion of the inner tube part; and
the outer tube downstream portion and the outer tube upstream portion are assembled to each other so as to be integrated into a unit.

3. The air-conditioning duct system as set forth in claim 2, wherein the outer tube downstream portion is a retainer of a register.
